(19) United States
(12) Patent Application Publication
(10) Pub. No.: US 2009/0066311 A1
(43) Pub. Date: Mar. 12, 2009

(54) PRE-CONDITIONER WITH LOW VOLTAGE COMPONENTS

(75) Inventor: Peter Luerkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,406

(22) PCT Filed: Nov. 3, 2005
(86) PCT No.: PCT/IB2005/053590

§ 371 Date: May 2, 2007

(30) Foreign Application Priority Data
Nov. 9, 2004 (EP) 04105644.1

(51) Int. Cl. G05F 3/08

(52) U.S. Cl. 323/311

(57) ABSTRACT

A pre-conditioner circuit comprising first and second pre-conditioner modules (10, 12), each having an input (Vin1, Vin2) and an output (Vout1, Vout2), the outputs (Vout1, Vout2) being coupled to respective load modules (14, 16). The output (Vout1, Vout2) of each pre-conditioner module (10, 12) is serially connected to the input (Vin2, Vin1) of the other pre-conditioner module (12, 10), such that an arbitrary series of parallel connection of the load modules (14, 16) can be achieved, depending on the rout voltage (Vin). Thus, low voltage components can be used in pre-conditioner modules (10, 12) and the load modules (14, 16), without the need for over-dimensioning.

This invention relates generally to a pre-conditioner or DC-to-DC converter which enables an application to operate with a wide range of input voltages.

A power supply is a device for the conversion of available power of one set of characteristics to another set of characteristics to meet specified requirements. Typical applications of power supplies include converting raw input power to a controlled stabilised voltage and/or current for the operation of electronic equipment.

Sometimes, a power supply is a buffer circuit that provides power with the characteristics required by the load from a primary power source with characteristics incompatible with the load, thereby making the load compatible with its power source. This buffer circuit is often termed a line conditioner or pre-conditioner.

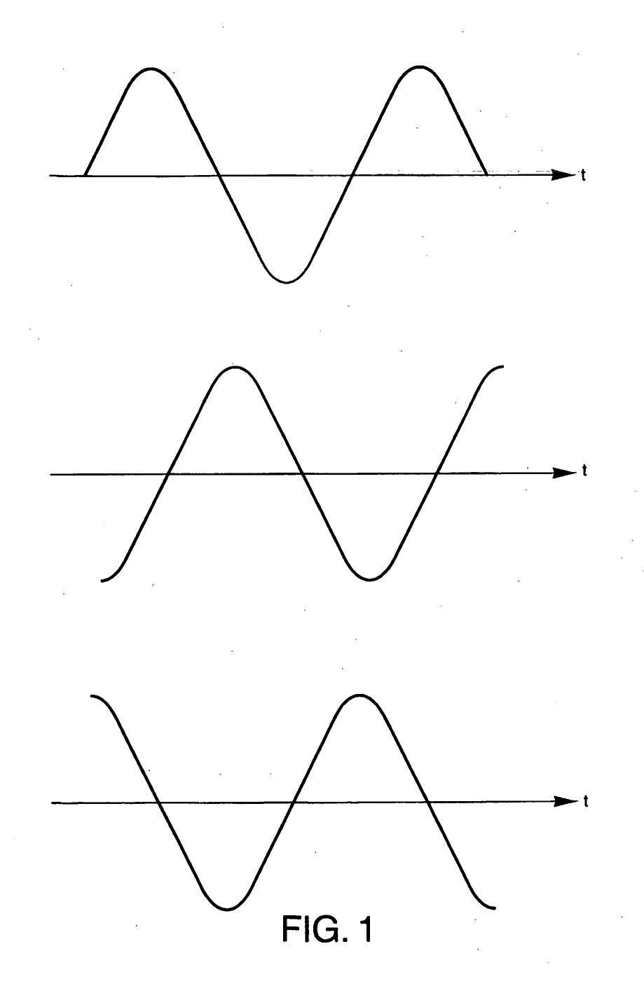

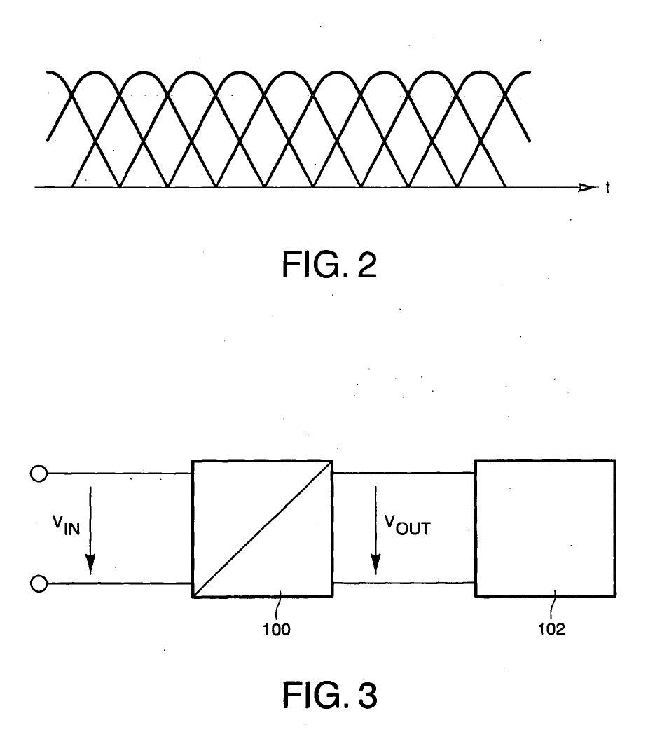

The simplest unregulated power supply consists of three parts: the transformer, the rectifiers and the capacitors. This kind of power supply is simple, but the resultant output voltage is not very stable (there can be a noticeable ripple in the output, and the output voltage changes with load changes and mains voltage changes). Medium power applications, such as X-ray generators and the like, are normally supplied by a three-phase utility network with a typical supply voltage of approximately 400V between phases. A three-phase alternating current (AC) line source is effectively supplied via three wires, each with a single phase AC that is one third cycle (120°) out of phase with the other two, as illustrated schematically in FIG. 1 of the drawings. A three-phase transformer is used in this type of application that has three sets of primary windings and three sets of secondary windings, i.e. in effect three separate high voltage interconnected transformers, and a rectifier network is employed to give a rectified output such as that illustrated in FIG. 2 of the drawings. A smoothing circuit, such as a capacitor connected in parallel with the load, is generally used to smooth the output waveform.

In the case of the above-mentioned three-phase utility network with a typical supply voltage of approximately 400V between phases, and considering all possible voltage variations, this leads to a rectified voltage ranging from around 400-750 V_{DC}. As a result, the power components of the subsequent application have need to be designed such that they will withstand the maximum voltage in this range and still deliver the required power at the minimum voltage. However, this excludes the usage of standard 500 V components and also requires a lot of over-dimensioning to provide the rated power at the lower voltages in the range.

Usually, in order to overcome some of these problems, some form of pre-conditioner is used to limit the input voltage to a reasonable range, or to raise the input voltage to a constant value, so as to eliminate the need for over-dimensioning in the subsequent circuitry. Referring to FIG. 3 of the drawings, a classical pre-conditioner configuration comprises a pre-conditioner or DC-to-DC converter module 100, connected to the power source V_{IN}, for generating a modified output voltage V_{OUT} for use in the main application 102. In general, the maximum voltage V_{IN} appearing at the power components of the pre-conditioner module 100 is at least the maximum voltage difference between any two terminals.

Many different types of pre-conditioner are known, which are typically DC-to-DC converters for stepping up the input voltage, stepping down the input voltage and/or maintaining the voltage supplied to the main application at a substantially constant level. In fact, U.S. Pat. No. 5,847,949 describes a boost converter for converting an input voltage received at an input thereof into first and second output voltages provided at first and second respective outputs thereof to respective portions of the main application.

One of the main disadvantages of the conventional solutions is that, although it is no longer necessary to design the components of the main application 102 to withstand the maximum input voltage while still delivering the desired power at the minimum voltage in the range, it is still necessary for the components of the pre-conditioning module 100 to be designed and over-dimensioned in this manner. In other words, the pre-conditioner module 100 is required to be designed to operate correctly within the wide input voltage range, and the same disadvantages in terms of component size and cost are encountered in this case as in the case where the application circuitry itself needs to be designed to withstand the full input voltage range.

We have now devised an improved arrangement, and it is an object of the present invention to provide pre-conditioning apparatus for an electrical application, which enables the application to operate within a relatively wide range of input voltages without the need for the components of either pre-conditioning apparatus or the electrical application to be specially designed to withstand the higher input voltages in the range and still deliver the desired power at the lower voltages in the range.

In accordance with the present invention, there is provided a pre-conditioner circuit having input terminals for receiving an input voltage, said pre-conditioner being for modifying said input voltage for application to a load, the pre-conditioner circuit comprising at least two pre-conditioner modules, each having an input and an output for connection to a respective load module, the output of each of said pre-conditioner modules being coupled in series with the input of another of said pre-conditioner modules, such that the input of each pre-conditioner module is dependent upon the pre-conditioner module output coupled thereto.

The present invention extends to a power supply module comprising a pre-conditioner circuit as defined above. The proposed can be understood as being able to realise effectively a gradual transition from a series to a parallel connection of load modules, depending on control, as will be apparent from the description herein.

Control means are beneficially provided for controlling the output of each of the pre-conditioner modules, and thereby controlling the input of the pre-conditioner modules to which said outputs are connected, by connecting one or more of said load modules in series and/or parallel. In other words, by the particular interconnection of the pre-conditioner (and load) module, an arbitrary series or parallel connection of the load modules can be achieved. This means that the maximum voltage occurring at any power component can be reduced to a maximum of ½ of modules by realising a full series connection of the load modules. At the same time, if the input voltage is low, a parallel connection of the load modules can be configured accordingly, such that over-dimensioning can also be avoided.

In one exemplary embodiment of the present invention, each of said pre-conditioner modules comprises switching means for alternately switching a respective pre-conditioner module on and off, and a control circuit is provided for controlling the duty cycle of said switching means. The control circuit is preferably arranged to switch said switching means of each pre-conditioner module with substantially the same pattern, which is phase-shifted by 180° (i.e. 360°/2), which results in reduced ripple in the converter's input current and lower stress on the high frequency components. The pre-conditioner modules may, for example, comprise step-up converters.

These and other aspects of the present invention will be apparent from, and elucidated with reference to, the embodiment described herein.

An embodiment of the present invention will now be described by way of example only and with reference to the accompanying drawings, in which:

FIG. 1 is a schematic illustration of the separate components of a three-phase voltage supply;

FIG. 2 is a schematic illustration of the three-phase rectified voltage;

FIG. 3 is a schematic block diagram of a pre-conditioner configuration relative to an electrical application according to the prior art;

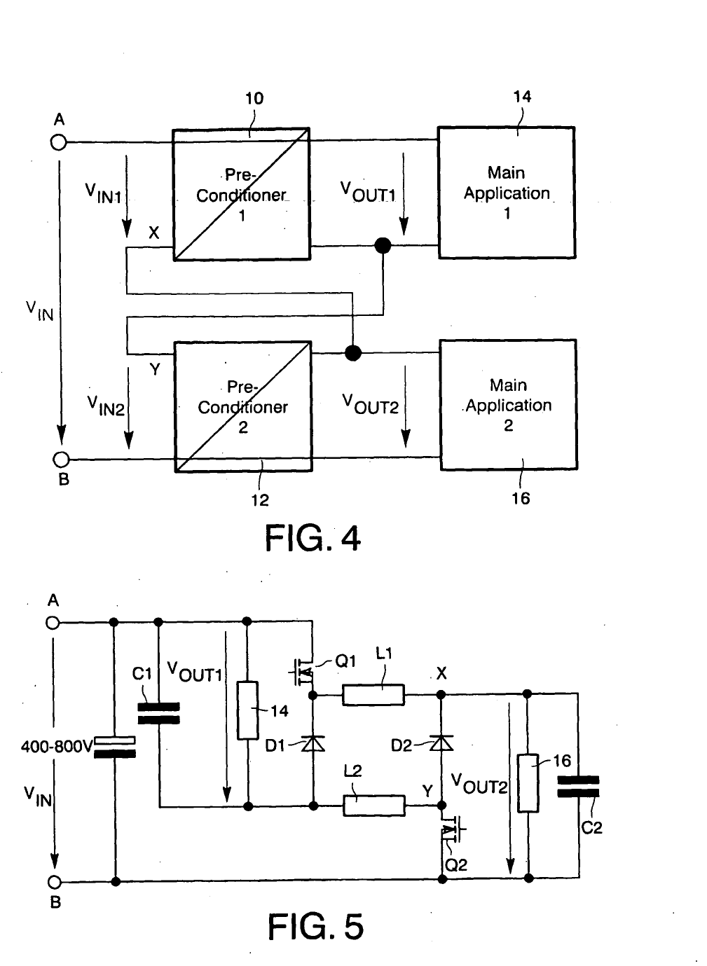

FIG. 4 is a schematic block diagram of a pre-conditioner configuration relative to an electrical application according to an exemplary embodiment of the present invention;

FIG. 5 is a schematic circuit diagram illustrating a specific realisation of the pre-conditioner configuration of FIG. 4;

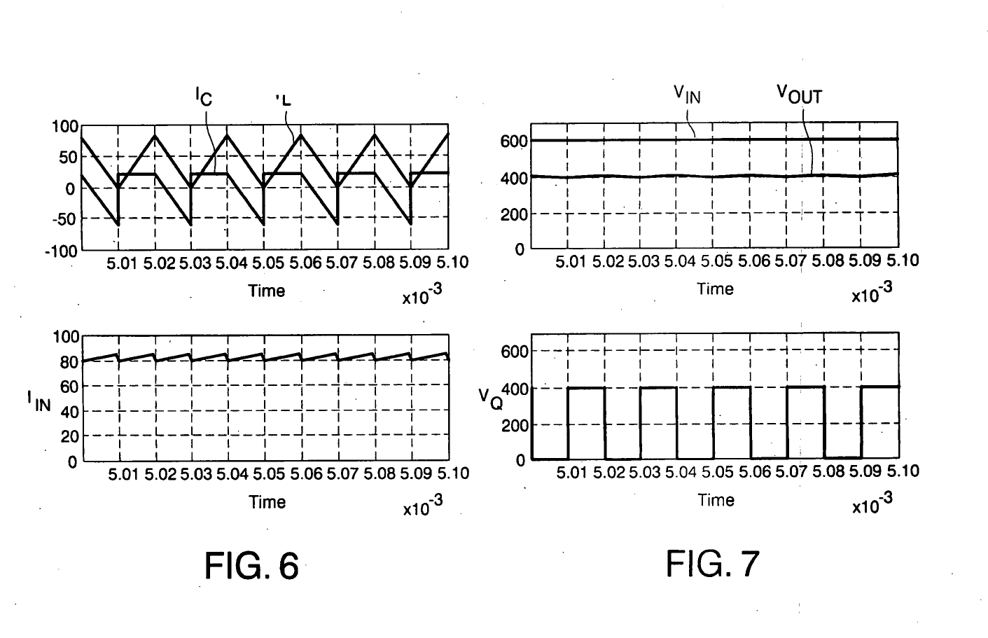

FIG. 6 illustrates the inductor and capacitor current and input current in respect of the circuit of FIG. 5; and

FIG. 7 illustrates the input and output voltages and switch voltage of the circuit of FIG. 5.

Referring to FIG. 4 of the drawings, a typical pre-conditioner arrangement according to an exemplary embodiment of the present invention comprises a DC supply (denoted by V_{IN}) across which is connected first and second pre-conditioner modules (or DC-DC converters) 10, 12 each having respective input terminals (denoted by V_{IN1} and V_{IN2} respectively) and output terminals (denoted by V_{OUT1} and V_{OUT2} respectively). The output terminals of the pre-conditioner modules 10, 12 are connected to first and second respective main applications 14, 16. As shown, the output V_{OUT1} of the first pre-conditioner module 10 is connected in series with the input of the second pre-conditioner module 12, and the output V_{OUT2} of the second pre-conditioner module 12 is connected in series with the input of the first pre-conditioner module 10. It is further assumed that the first pre-conditioner module 10 produces an output whose upper voltage rail has the same electrical potential as the upper voltage rail of the input voltage, while the second pre-conditioner module 12 produces an output whose lower voltage rail has the same electrical potential as the lower voltage rail of the input voltage.

As a result, the maximum input voltage to each of the pre-conditioner modules 10, 12 is reduced relative to the supply input V_{IN}. In particular, the input voltage of the first pre-conditioner module 10 follows the rule:

V_{IN1}=V_{IN}−V_{OUT2}

and the input voltage of the second pre-conditioner module 12 follows the rule:

V_{IN2}=V_{IN}−V_{OUT1}.

Depending on the topology of the pre-conditioner modules 10, 12, it is possible to determine the resultant useful range of the voltage V_{OUT} for each pre-conditioner module. For example, if the pre-conditioner modules 10, 12 comprise up-converters, i.e. its input voltage is always less than its output voltage, it is possible to obtain a range for V_{OUT} for each pre-conditioner module, as follows:

0<V_{IN1/2}=V_{IN}−V_{OUT}<V_{OUT}=>V_{IN}/2<V_{OUT}<V_{IN}

In other words, by control, it is possible to reduce V_{OUT} of each up-converter if the respective V_{IN} thereof is too high but not less than V_{IN}/2.

Referring to FIG. 5 of the drawings, there is illustrated a practical circuit implementation of the architecture illustrated in FIG. 4. In the case of the circuit of FIG. 5, the main applications 14, 16 (i.e. the loads) are considered to be simple resistors, and the pre-conditioner modules 10, 12 are of the up-converter type to provide an output voltage as outlined above.

The basic components of an up-converter (or step-up converter) consist of an inductor, a transistor (i.e. a switch) and a diode. Thus, in the circuit of FIG. 5, the pre-conditioner module 1 comprises a capacitor C1 connected in parallel with a resistor 14. The switch is provided by an n-channel IGFET (Insulated Gate Field Effect Transistor) Q1, in respect of which a diode D1 is provided. Similarly, pre-conditioner module 2 comprises capacitor C2, resistor 16, switch Q2 and diode D2. V_{IN1} appears between nodes A and X and V_{IN2} appears between nodes B and Y, and V_{OUT1} and V_{OUT2} are dropped across loads 14, 16 respectively, as shown.

A control circuit (not shown) is provided to control switching of the transistors Q1, Q2, whereby control of the pre-conditioner modules is realised by the duty cycle of the power transistors Q1, Q2. In a preferred embodiment, both transistors Q1, Q2 are switched with a pattern that is phase-shifted by 180°, which results in a reduced ripple in respect of each converter's input current and lower stress on the filter capacitors.

An understanding of the functioning of the circuit can be obtained by looking at two extreme cases first. The first extreme case considers both power transistors Q1, Q2 constantly turned off. In this case the supply current first flows through the load resistor 14. It then separates into two fractions, one flowing over diode D1 and inductor L1, the other over inductor L2 and diode D2. In the joint of D2 and L1 the two fractions are united again, thereafter the current flows through the load resistor 16 to ground. In effect, the load modules are now connected in series, meaning the each load module accepts half of the input voltage V_{IN}.

In the second extreme case the two power transistors are considered turned on continuously. In this case the load resistor 14 is connected to ground over inductor L2 and transistor Q2. The inductor L1 remains ineffective for the average current. The load resistor 16 is connected to the high side supply voltage over inductor L1 and transistor Q1. In effect the two load resistors are connected in parallel, meaning that each load module accepts the full input voltage.

By adjusting the duty cycle of the two power transistors in between the two boundary cases, an adjustable supply voltage V_{IN1}, V_{IN2} of the two load modules between 50% and 100% of the input voltage V_{IN} can be achieved.

It will be apparent from the circuit illustrated in FIG. 5 that:

V_{IN1}=V_{IN}−V_{OUT2} and

V_{IN2}=V_{IN}−V_{OUT1}

as described with reference to the architecture illustrated in FIG. 4.

FIG. 6 illustrates typical current waveforms I_{L} in one of the inductors and I_{C} in the filter capacitor, and also I_{IN} at the input, and FIG. 7 illustrates the corresponding voltages V_{IN} and V_{OUT}, as well as the switch voltage V_{Q}. It can be seen that, even at the higher input voltage, the voltage at the power switch (Q1 or Q2) is only 400V.

Thus, the present invention takes advantage of the fact that a large number of applications can be separated into two equal sub-modules, and this is done with the pre-conditioner module. By the special arrangement of the pre-conditioner and load modules, an arbitrary series or parallel connection of the modules can be achieved. This means that the maximum voltage, occurring at any power component, can be reduced to a maximum of half of the input voltage by realising a full series connection of the load modules. This enables 500V (and theoretically even 400V) components when a maximum input voltage of, say, 800V has to be taken into consideration. At the same time, the sliding configuration of the modules, allows for a parallel connection when the input voltage is low. As a result, low voltage components can be used and, at the same time, over-dimensioning can be avoided.

The present invention is considered to be particularly useful for use with X-ray generators, as these are typically supplied by a weak three-phase utility network, where a large input voltage range has to be considered. The arrangement of the present invention permits the use of 500V components in the entire generator except the input rectifier. This reduces cost and keeps losses low. Other potential applications include telecommunications power supplies, that also have a high degree of parallelization and are required to cover a wide input voltage range.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A pre-conditioner circuit having input terminals, for receiving an input voltage (Vin), said pre-conditioner being for modifying said input voltage (Vin) for application to a load, the pre-conditioner circuit comprising at least two pre-conditioner modules (10, 12), each having an input (Vin1, Vin2) and an output (Vout1, Vout2) for connection to a respective load module (14, 16), the output of each of said pre-conditioner modules (10, 12) being coupled in series with the input of another of said pre-conditioner modules (10, 12), such that the input of each pre-conditioner module (10, 12) is dependent upon the pre-conditioner module output (Vout1, Vout2) coupled thereto.

2. A circuit according to claim 1, comprising means for enabling the output (Vout2, Vout1) of each of the pre-conditioner modules (10, 12) and thereby the input (Vin1, Vin2) of the pre-conditioner modules (12, 10) to which said outputs (Vout2, Vout1) are connected, to be controlled by connecting one or more of said load modules (14, 16) in series and/or parallel.

3. A circuit according to claim 1, wherein each of said pre-conditioner modules (10, 12) comprises switching means (Q1, Q2) for alternately switching a respective pre-conditioner module (10, 12) on and off, and a control circuit is provided for controlling the duty cycle of said switching means (Q1, Q2).

4. A circuit according to claim 3, wherein the control circuit is arranged to switch said switching means (Q1, Q2) of each pre-conditioner module (10, 12) with substantially the same pattern, which is phase-shifted.

5. A circuit according to claim 4, wherein said phase shift is substantially 180°.

6. A circuit according to claim 1, wherein said pre-conditioner modules (10, 12) comprise step-up converters.

7. A power supply module comprising a pre-conditioner circuit according to claim 1.
